(19) United States
(12) Patent Application Publication
(10) Pub. No.: US 2011/0156902 A1
(43) Pub. Date: Jun. 30, 2011

(54) SURFACE MOUNTED TECHNOLOGY MONITORING SYSTEM AND METHOD

(75) Inventors: CHI-CHIH WANG, Tu-Cheng (TW); RUI-JUN WANG, Shenzhen City (CN); XU-KUN WANG, Shenzhen City (CN); ZHI-LONG LI, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/792,739

(22) Filed: Jun. 3, 2010

(30) Foreign Application Priority Data
Dec. 30, 2009 (CN) 200910312586.4

(51) Int. Cl. G08B 21/00

(52) U.S. Cl. 340/540

(57) ABSTRACT

A Surface Mounted Technology (SMT) monitoring system and method includes setting an alarm threshold of an accident probability, and obtaining the output data from a monitor unit. The SMT monitoring method further includes calculating the accident probability according to the obtained output data, and sending an alarm command to trigger an alarm unit located at the SMT production lines to output an alarm signal if the calculated accident probability is greater than or equal to the set alarm threshold of the accident probability.

### BACKGROUND

1. Field of the Invention

Embodiments of the present disclosure relate to monitoring system and method, and in particular, to a Surface Mounted Technology (SMT) monitoring system and the method thereof.

2. Description of Related Art

Nowadays, increasingly, electronic products are manufactured using SMT technology. However, flammable material used in SMT apparatuses or high temperature ovens may result in fire accidents and explosions. Accordingly, it is becoming more important to prevent the accidents from happening to ensure the safety of life and property.

What is needed, therefore, is an improved system and method to overcome the aforementioned problem.

### BRIEF DESCRIPTION OF THE DRAWINGS

FIG. 1 is a block diagram of one embodiment of a SMT monitoring system.

FIG. 2 is a block diagram of one embodiment of the monitoring module.

FIG. 3 is a flowchart of one embodiment of a method for the SMT monitoring system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may included connected logic units, such as gates and flip-flops, and may include programmable units, such as programmable gate arrays or processors. The modules described herein may be implemented as either software and/or hardware modules and may be stored in any type of computer-readable medium or other computer storage device.

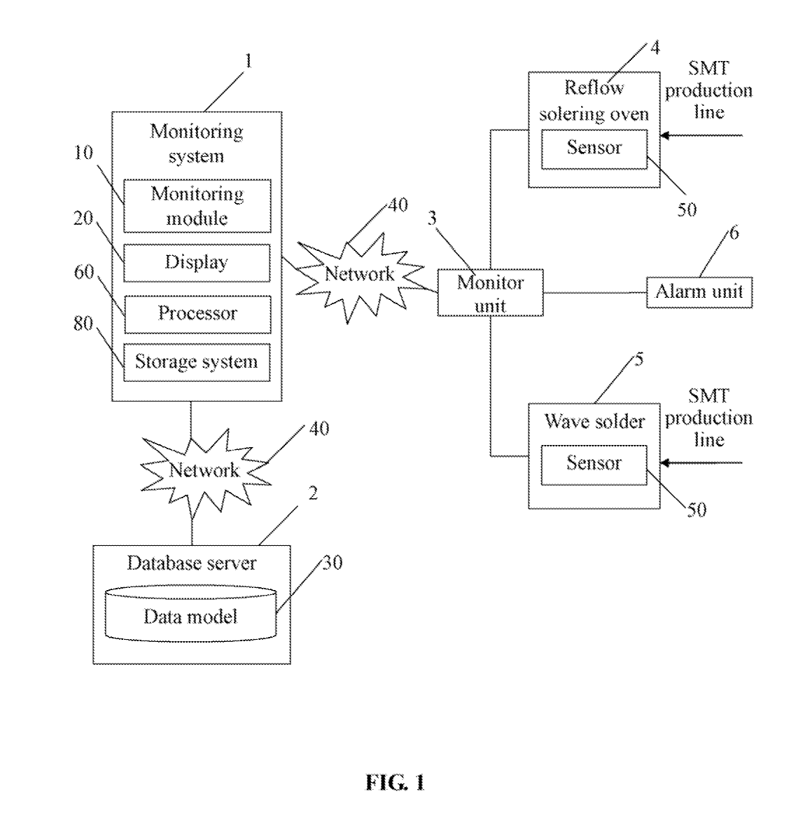

FIG. 1 is a block diagram of one embodiment of a SMT monitoring system 1 including a monitoring module 10. The SMT monitoring system 1 may output alarm signals according to output data of SMT production lines. In some embodiments, the SMT production lines are assembly lines of SMT assembly manufacturing including a plurality of SMT machines, such as, a reflow soldering oven 4 and a wave solder 5. The SMT monitoring system 1 communicates with a monitor unit 3 through a network 40. The monitor unit 3 may monitor the output data of the SMT production lines using a plurality of sensors 50. The output data of the SMT production lines may include, but are not limited to, temperature, volatile concentration, and ventilation rate of the SMT production lines.

In some embodiments, the sensors 50 are installed on the reflow soldering oven 4 and the wave solder 5. The sensors 50 may include a temperature sensor, a concentration sensor, a wind speed sensor, or a plurality of different environmental sensors. The sensors 50 collect the output data of the SMT production lines in a real-time manner, and transmit the output data to the monitor unit 3. The monitor unit 3 further controls an alarm unit 6 located near the SMT production lines to output alarm signals.

The SMT monitoring system 1 obtains output data from the monitor unit 3 by a polling method. In one embodiment, if there is only one monitor unit 3, the SMT monitoring system 1 accesses the monitor unit 3 in a predetermined interval. In other embodiments, if there is a plurality of monitor units 3, the SMT monitoring system 1 accesses the monitors system 3 to obtain data according to a predetermined sequence and a predetermined interval.

In one embodiment, the output data may be saved into a database server 2 for users to query from the Internet.

The SMT monitoring system 1 further accesses at least one data model 30 of the database server 2 through the network 40. The data model 30 includes historical accident probabilities of accidents of the SMT production lines corresponding to the output data. The historical accident probability in the data model 30 is analyzed and summarized by historical data and research analysis. For example, if a range of the temperature of a SMT production line is between 35 degrees C. to 40 degrees C., a range of the volatile concentration is between 25 PPM to 30 PPM, and a range of the ventilation rate is between 1 m/s to 3 m/s, the accident probability may be calculated as 1%.

The SMT monitoring system 1 further includes a display 20, a processor 60 and a storage system 80. The storage system 80 may be a memory system of the SMT monitoring system 1, and also may be an external storage card, such as a smart media (SM) card, or secure digital (SD) card, for example.

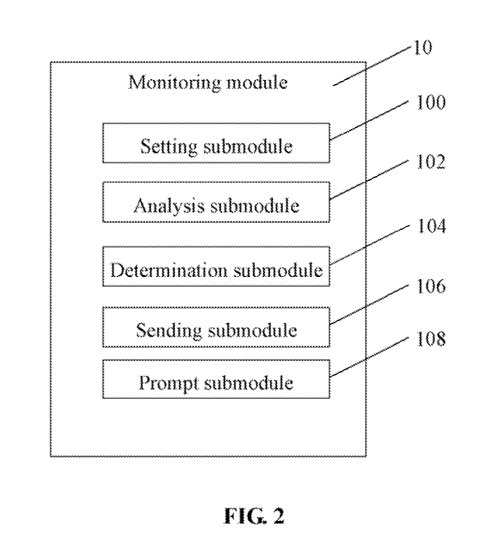

FIG. 2 is a block diagram of one embodiment of the monitoring module 10. The monitoring module 10 includes a setting submodule 100, an analysis submodule 102, a determination submodule 104, a sending submodule 106, and a prompt submodule 108. The submodules 100, 102, 104, 106, and 108 may include one or more computerized codes to be executed by the processor 60 to perform one or more operations of the monitoring module 10. Details of these operations will be provided below.

In some embodiments, the setting submodule 100 sets an alarm threshold of the accident probability of the SMT production lines, an alarm e-mail, and e-mail addresses of receivers of the alarm e-mail. For example, the alarm threshold of the accident probability may set as 30%, and the alarm e-mail is sent to the e-mail addresses of relevant personnel.

The analysis submodule 102 obtains the output data from the monitor unit 3. As mentioned above, the output data may include, but are not limited to, the temperature, the volatile concentration, and the ventilation rate of the SMT production lines. The analysis submodule 104 further calculates the accident probability of the SMT production lines according to the obtained output data by accessing the data model 30. The analysis submodule 102 then saves the obtained output data into the database server 2 for users to query from the Internet.

The determination submodule 104 determines whether the calculated accident probability is greater than or equal to the set alarm threshold of the accident probability.

If the calculated accident probability is greater than or equal to the alarm threshold, the sending submodule 106 sends an alarm command to the monitor unit 3. The monitor unit 3 then relays the alarm command to the alarm unit 6 located at the SMT production lines to output alarm signals. In one embodiments, the sending submodule 106 further sends the alarm e-mail to the set mail addresses of receivers for informing relevant personnel.

In addition, if the calculated accident probability is greater than or equal to the alarm threshold, the prompt submodule 108 displays an alarm message on the display 20 of the SMT monitoring system 1. For example, the alarm message may be “Warning: SMT production lines in dangerous condition! Please handle and adjust quickly”.

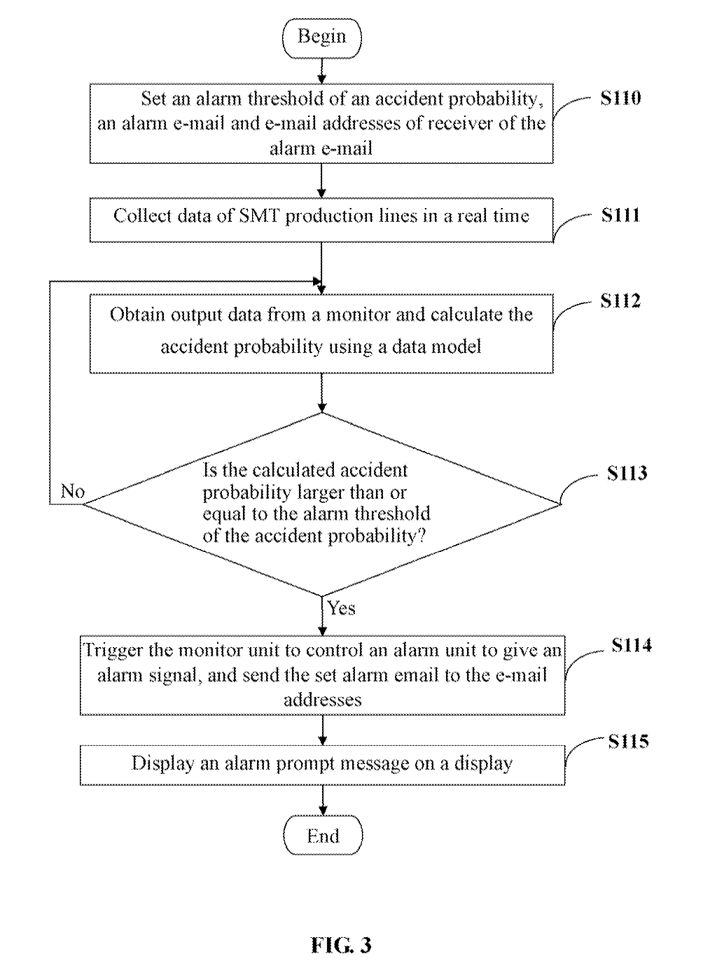

FIG. 3 is a flowchart of one embodiment of a method for the SMT monitoring system of FIG. 1. Depending on the embodiment, additional blocks may be added, others removed, and the ordering of the blocks may be changed.

In block S110, the setting submodule 100 sets an alarm threshold of an accident probability, an alarm e-mail and e-mail addresses of receivers of the alarm e-mail.

In block S111, the sensors 50 installed on the reflow soldering oven 4 and wave solder 5 collect data of the SMT production lines, and transmit the output data of the SMT production lines to the monitor unit 3. The output data of the SMT production lines include the temperature, the volatile concentration and the ventilation rate of the SMT production lines.

In block S112, the analysis submodule 102 obtains the output data from the monitor unit 3. In addition, the analysis module 104 further calculates the accident probability of the SMT production lines according to the obtained output data by the data model 30 of the database sever 2. In one embodiment, the analysis submodule 102 saves the obtained output data into the database server 2 for users to query from the Internet.

In block S113, the determination submodule 104 determines whether the calculated accident probability is greater than or equal to the set alarm threshold of the accident probability.

If the calculated accident probability is greater than or equal to the alarm threshold, in block S114, the sending submodule 106 sends an alarm command to trigger the alarm unit 6 to output the alarm signal. In addition, the sending submodule 106 sends the alarm e-mail to the e-mail addresses of receivers of the alarm e-mail. If the calculated accident probability is lower than the set alarm threshold of the accident probability, the procedure goes back to S112.

In block S115, the prompt submodule 108 displays an alarm message on a display 20 of the SMT monitoring system 1.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A Surface Mounted Technology (SMT) monitoring system, the SMT monitoring system in communication with a monitor unit monitoring SMT production lines, the SMT monitoring system comprising:
a storage system;
a display;
at least one processor; and
one or more programs stored in the storage system and being executable by the at least one processor, the one or more programs comprising:
a setting module operable to set an alarm threshold of an accident probability of the SMT production lines;
an analysis module operable to obtain output data of the SMT production lines from the monitor unit, and to calculate the accident probability according to the obtained output data using at least one data model of a database server in communication with the SMT monitoring system;
a determination module operable to determine whether the calculated accident probability is greater than the set alarm threshold of the accident probability;
a sending module operable to send an alarm command to trigger an alarm unit located near the SMT production lines to output an alarm signal if the calculated accident probability is greater than or equal to the set alarm threshold of the accident probability.

2. The system as described in claim 1, wherein the alarm command is relayed to the alarm unit by the monitor unit.

3. The system as described in claim 1, wherein the setting module is further operable to set an alarm e-mail and e-mail addresses of receivers of the alarm e-mail.

4. The system as described in claim 2, wherein the sending module is further operable to send the alarm e-mail to the e-mail addresses if the calculated accident probability is greater than or equal to the set alarm threshold of the accident probability.

5. The system as described in claim 1, wherein the one or more programs further comprise a prompt module operable to display an alarm message on the display of the system if the calculated accident probability is greater than or equal to the set alarm threshold of the accident probability.

6. A method for a SMT monitoring system, the monitoring system in communication with a monitor unit monitoring SMT production lines, the method comprising:
setting an alarm threshold of an accident probability of the SMT production lines;
obtaining output data of the SMT production lines from the monitor unit;
calculating the accident probability according to the obtained output data using at least one data model of a database server in communication with the SMT monitoring system;
determining whether the calculated accident probability is greater than or equal to the set alarm threshold of the accident probability; and
sending an alarm command to trigger an alarm unit located at the SMT production lines to output an alarm signal if the calculated accident probability is greater than or equal to the set alarm threshold of the accident probability.

7. The method as described in claim 6, wherein the alarm command is relayed to the alarm unit by the monitor unit.

8. The method as described in claim 6, further comprising:
returning to the obtaining step if the calculated accident probability is lower than the set alarm threshold of the accident probability.

9. The method as described in claim 6, further comprising:
setting an alarm e-mail and e-mail addresses of receivers of the alarm e-mail.

10. The method as described in claim 9, further comprising:
sending the alarm e-mail to the e-mail addresses if the calculated accident probability is greater than or equal to the set alarm threshold of the accident probability.

11. The method as described in claim 5, further comprising:
displaying an alarm message on a display of the SMT monitoring system if the calculated accident probability is greater than or equal to the set alarm threshold of the accident probability.

12. A storage medium storing a set of instructions, the set of instructions capable of being executed by a processor to perform a method for a SMT monitoring system, the SMT monitoring system in communication with a monitor unit monitoring SMT production lines, the method comprising:
setting an alarm threshold of an accident probability of the SMT production lines;
obtaining output data of the SMT production lines from the monitor unit, and calculating the accident probability according to the obtained data using at least one data model of a database server in communication with the SMT monitoring system;
determining whether the calculated accident probability is greater than or equal to the set alarm threshold of the accident probability; and
sending an alarm command to trigger an alarm unit located at the SMT production lines to output an alarm signal if the calculated accident probability is greater than or equal to the set alarm threshold of the accident probability.

13. The storage medium as described in claim 11, wherein the alarm command is relayed to the alarm unit by the monitor unit.

14. The storage medium as described in claim 11, further comprising:
returning to the obtaining step if the calculated accident probability is lower than the set alarm threshold of the accident probability.

15. The storage medium as described in claim 11, further comprising:
setting an alarm e-mail, and setting e-mail addresses of receivers of the alarm e-mail.

16. The storage medium as described in claim 14, further comprising:
sending the alarm to the e-mail addresses if the calculated accident probability is greater than or equal to the set alarm threshold of the accident probability.

17. The storage medium as described in claim 11, wherein the method further comprises:
displaying an alarm message on a display of the SMT monitoring system if the calculated accident probability is greater than or equal to the set alarm threshold of the accident probability.
